(19) United States
(12) Patent Application Publication
(10) Pub. No.: US 2017/0182485 A1
(43) Pub. Date: Jun. 29, 2017

(54) IONIC LIQUID-SOLVENT COMPLEX, PREPARATION AND APPLICATIONS THEREOF

(71) Applicant: RELIANCE INDUSTRIES LIMITED, Mumbai (IN)

(72) Inventors: Parasuveera Uppara, Navi Mumbai (IN); Vivek RAJE, Washim (IN); Pavankumar ADURI, Dombivali (IN); Vibhuti DUKHANDE, Mumbai (IN)

(73) Assignee: RELIANCE INDUSTRIES LIMITED, Mumbai (IN)

(21) Appl. No.: 15/325,422

(22) PCT Filed: Jul. 10, 2015
(86) PCT No.: PCT/IB2015/055228

§ 371 Date: Jan. 10, 2017

(30) Foreign Application Priority Data
Jul. 11, 2014 (IN) 2280/MUM/2014

(51) Int. Cl. B01J 31/02

(52) U.S. Cl. CPC B01J 31/0249; B01J 31/0279; B01J 31/0247; B01J 2231/32

(57) ABSTRACT

The present disclosure relates to ionic liquid-solvent complex comprising cation and anion and are prepared in the presence of a solvent. The present disclosure also relates to the process for preparing ionic liquid-solvent complex and also to a process for producing linear alkyl benzene using the ionic liquid-solvent complex. The present disclosure also relates to various applications of the ionic liquid-solvent complex.

### TECHNICAL FIELD

The present disclosure relates to the field of Organic Chemistry. Particularly, the present disclosure relates to ionic liquid-solvent complex.

The present disclosure also relates to the preparation of ionic liquid-solvent complex and its application, without limiting to its application in chemical and biological reactions, electric battery or cells, treating contaminated water, purification of gases and as catalyst, solvent etc. Also, the present disclosure relates to the production of Linear alkyl benzenes (LAB) using the Ionic liquid-solvent complex.

### BACKGROUND OF THE DISCLOSURE

Salts are ionic compounds that result from the neutralization reaction of an acid and a base. They are composed of related numbers of cations (positively charged ions) and anions (negatively charged ions) so that the product is electrically neutral (without a net charge). These component ions can be inorganic or organic, and salts as a whole can be monatomic, or polyatomic. Salts may be in solid form or liquid form, and salts in liquid state are known as ionic liquids.

Ionic liquids are liquids that are composed entirely of ions or a combination of cations and anions. The so-called “low temperature” Ionic liquids are generally organic salts with melting points less than 100 degrees C., often even lower than room temperature. Ionic liquids are suitable, for example, as catalysts and solvents in alkylation and polymerization reactions as well as in dimerization, oligomerization, acetylation, metatheses and copolymerization reactions.

Conventionally, such reactions are carried out using various catalysts available in the prior art. For example: alkylbenzenes which are very important raw material for the manufacture of detergents are manufactured by alkylation of benzenes by a process wherein benzene is reacted with an olefin to produce alkylbenzene. The alkylation conditions comprise the presence of homogeneous or heterogeneous alkylation catalyst such as aluminium chloride, boron trifluoride, sulfuric acid, hydrofluoric acid, phosphoric acid and zeolitic catalysts and elevated temperature.

The majority of the commercial plants for such alkylation reactions use hydrogen fluoride (HF) as an acid catalyst. However, HF based process provide operational concerns in terms of safety, toxicity, volatility, corrosiveness, waste disposal and troublesome acid recovery and its purification. Solid acid catalysts such as UOP Detal have been developed recently to replace HF. But this solid acid catalyst technology cannot be retrofitted in the HF based technology manufacturing plants. An alternative to HF for preparation of linear alkyl benzenes explored in the prior art is ionic liquids.

In terms of composition, one class of ionic liquids reported is fused salt compositions, which are molten at low temperature and are useful as catalysts, solvents and electrolytes. Such compositions are mixtures of components which are liquids at temperatures below the individual melting points of the components.

Ionic liquids can be defined as liquids whose make-up entirely comprises ions as a combination of cations and anions. The most common ionic liquids are those prepared from organic-based cations and inorganic or organic anions. The most common organic cations are ammonium cations, but phosphonium and sulphonium cations are also frequently used. Ionic liquids of pyridinium and imidazolium are perhaps the most commonly used cations. Anions include, but are not limited to BF⁴⁻, PF⁶⁻, haloaluminates such as Al2Cl7- and Al2Br7-, [(CF3SO2)2N)]—, alkyl sulphates (RSO3-), carboxylates (RCO2-) and many others. The most catalytically interesting ionic liquids are those derived from ammonium halides and Lewis acids (such as AlCl₃, TiCl₄, SnCl₄, FeCl₃ and the like). Chloroaluminate ionic liquids are perhaps the most commonly used ionic liquid catalyst systems.

WO/2011/064556 discloses formation of a mixture having a freezing point of upto 100° C. formed by contacting 1 mole of AlX3, where X can be Cl, Br, F with 1 or 2 moles of R¹—C(O)—N(R²)(R³), where R1 to R3 can be alkyl, aryl or substituted alkyl and aryl. This mixture can be used for electro-reduction of the mixture to produce aluminium metal. It also discloses the solid formation of AlX3 with 3 moles of Amide. However, it does not suggest further reaction of that complex with AlX3. Also, this mixture sometimes requires heating to form a good mixture, having freezing point up to 100° C.

U.S. Pat. No. 8,518,298 discloses formation of a mixture having a freezing point of up to 50° C., wherein the mixture is formed by reaction between: (A) one molar equivalent of a salt of formula I (Mn+)(X-)n I or a hydrate thereof; and (B) from one to eight molar equivalents of a complexing agent comprising one or more uncharged organic compounds, each of which compounds has (i) a hydrogen atom that is capable of forming a hydrogen bond with the anion X—; and (ii) a heteroatom selected from the group consisting of O, S, N and P that is capable of forming a coordinative bond with the metal ion Mn+, wherein the reaction is performed in the absence of extraneous solvent. Where M is metallic elements selected from the group consisting of Mg, Ca, Cr, Mn, Fe, Co, Ni, Cu, Zn, Ga, Ge, In, Sn, Ti, Pb, Cd, Hg and Y, and X is one or more monovalent anions selected from the group consisting of halide, nitrate and acetate. The ratio of A:B is varied from 1:8. However, there is no disclosure about further reaction of adduct with (Mn+)(X-)n.

Formation of Ionic Liquid from a large, organic cation and an anion that can coordinate to the metal ion is known in the art. Also, addition of Lewis acid to the Lewis base for the formation of adduct/Ionic Liquid by heating is well known in the art.

Xuewen et al., Chinese Journal of Chemical Engineering, 2006, 14, 289-293 describes [bmim]Cl/[FeCl3] ionic liquid as a catalyst for alkylation of benzene with 1-Octadecene. Similarly, Z H U et al., Bulletin of the Catalysis Society of India, 2007, 6, 83-89 discloses the use of chloroaluminate ionic liquid for the alkylation of benzene with mixture of alkenes and alkanes.

U.S. Pat. No. 7,285,698 discloses a method for isobutane and C4 olefin alkylation using a composite ionic liquid as catalyst. The said ionic liquid comprises of a cation which is a hydrohalide of an alkyl-containing amine or pyridine and an anion which is a mixture of aluminum halide and halides or sulphates or nitrates of copper, iron, zinc, nickel, cobalt, molybdenum or platinum.

All the above reported ionic liquids and the processes mentioned suffer a disadvantage of the resulting ionic liquids having high viscosity of ionic liquid. Also, the preparation of some ionic liquids by just addition of Lewis base to metal salts requires heating. Most importantly, the ionic liquids of the prior art are required in large amounts for carrying out such reactions. The present disclosure overcomes the limitation of the prior art by disclosing ionic liquid-solvent complex, wherein the ionic liquid is synthesized in the presence of solvent forming a complex with the same and having various advantages, including but not limiting to, having very less viscosity, no requirement of heating during the process, longer shelf life and ensures minimal use of catalyst (ionic liquid) required for reactions.

The present disclosure also provides for an improved method for performing alkylation of benzene for producing enhanced biodegradable linear alkylbenzenes with safer homogeneous acid catalysts and can be retrofitted in the HF based manufacturing plant with minimum or no modifications. The ionic liquid used in the instant process reduces the cost as well as time required for the alkylation of linear alkyl benzenes. Thereby, making the process of alkylation faster and cheaper.

### SUMMARY OF THE DISCLOSURE

The present disclosure relates to ionic liquid-solvent complex, and the solvent in the complex is, including but not limiting to, organic solvent.

In an embodiment, the ionic liquid-solvent complex of the present disclosure is used for catalysing reactions, wherein the ionic liquid-solvent complex minimizes the amount of ionic-liquid (catalyst) required for carrying out a reaction.

In some embodiments, the present disclosure relates to process for preparation of ionic liquid-solvent complex, wherein the solvent is added during the preparation of ionic liquid. In an exemplary embodiment of the present disclosure, the solvent is added while preparation of ionic liquid and hence, no heating is required for the formation of ionic liquid. The ionic liquid-solvent complex so prepared has very less viscosity and improves the transport properties of the ionic liquid thereby overcoming resistances during various catalytic reaction process.

In some embodiments of the present disclosure, ionic liquid-solvent complex is suitable for applications, including but not limiting to, chemical and biological reactions, electric battery or cells, treating contaminated water, purification of gases and as, catalyst, solvent etc.

### BRIEF DESCRIPTION OF THE ACCOMPANYING FIGURES

In order that the disclosure may be readily understood and put into practical effect, reference will now be made to exemplary embodiments as illustrated with reference to the accompanying figures. The figures together with a detailed description below, are incorporated in and form part of the specification, and serve to further illustrate the embodiments and explain various principles and advantages, in accordance with the present disclosure where:

FIG. 1 depicts the flow diagram representing the sequence of unit operations involved during the alkylation of benzene with olefins wherein: (M1) represents first mixer; (M2) represents second mixer; (S1) represents first settler; (M3) represents third mixer; (S2) represents second settler, (PR) represents purifier which can be a stirred vessel or centrifuge separator or packed column packed with alumina to remove acid traces; (S3) represents third settler; (D1) represents first fractionating column; (D2) represents second fractionating column; (D3) represents third fractionating column; (CRU) represents catalyst recovery unit.

FIG. 2 depicts the NMR study of the liquid clathrate formation, which shows protons of benzene going up field (from 6.614 to 4.892 ppm) after the clathrate formation.

### DETAILED DESCRIPTION OF THE DISCLOSURE

As used herein, the terms “Ionic liquid”, “Urea based Ionic liquid”, and “Catalyst” have been used interchangeably in the present disclosure unless indicated otherwise on the contrary.

The present disclosure relates to ionic liquid-solvent complex, wherein the ionic liquid comprises a cation and an anion in a complex with an organic solvent.

In an embodiment, the present disclosure relates to ionic liquid-solvent complex represented by formula I,

[UMᵢXⱼ]S;

wherein,

[UMᵢXⱼ] represents the ionic liquid and S represents organic solvent;

wherein,
U represents cation selected from group comprising amide, phosphine and phosphine Oxide;
[MᵢXⱼ] represents anion; wherein M represents metal selected from a group comprising Al, Fe, Zn, Mn, Mg, Ge, Cu and Ni; X represents halogen selected from a group comprising F, Cl, Br and I; and i and j represents 1 to 6.

In an exemplary embodiment of the present disclosure, the amide is selected from group comprising urea and dimethylformamide.

In a preferred embodiment of the present disclosure, the amide is Urea.

In another exemplary embodiment of the present disclosure, the phosphine is triphenylphosphine.

In an embodiment of the present disclosure, the solvent is selected from a group comprising benzene, toluene, ethyl acetate, ethanol, acetic acid, acetone, acetonitrile, butanol, t-butyl alcohol, carbon tetrachloride, chlorobenzene, chloroform, cyclohexane, 1,2-dichloroethane, heptane, hexane, methanol, methylene chloride, nitromethane, pentane, propanol and xylene.

In another embodiment of the present disclosure, the solvent is an aromatic solvent selected from a group comprising benzene, toluene, chlorobenzene, cyclohexane and xylene.

In an exemplary embodiment of the present disclosure, the solvent is benzene or toluene.

In a preferred embodiment of the present disclosure, the solvent is benzene.

In a non-limiting embodiment of the present disclosure, the solvent forms a clathrate with the ionic liquid [UMiXj].

In a preferred embodiment of the present disclosure, the ionic liquid-solvent complex [UMiXj]S is [Urea-AlCl3]-benzene.

In another embodiment, the ionic liquid solvent complex of the present disclosure minimizes the amount of ionic liquid [UMᵢXⱼ] required as a catalyst for carrying out reactions.

The present disclosure also relates to a process of preparation of the ionic liquid-solvent complex of formula I:

[UMᵢXⱼ]S;

wherein,

[UMᵢXⱼ] represents the ionic liquid and S represents organic solvent;

wherein,
U represents cation selected from group comprising amide, phosphine, phosphine Oxide and urea;
[MᵢXⱼ] represents anion; wherein M represents metal selected from a group comprising Al, Fe, Zn, Mn, Mg, Ge, Cu and Ni; X represents halogen selected from a group comprising F, Cl, Br and I; and i and j represents 1 to 6.

In an embodiment of the present disclosure, the process for preparing the ionic liquid-solvent complex comprises acts of:
a. adding organic solvent to a flask charged with cation under N₂ atmosphere and stirring reaction mixture for a time period ranging from about 10 minutes to 50 minutes;
b. immersing the flask in a water bath kept at a temperature ranging from about 10-40° C. and adding anion under slow stirring of the reaction mixture for a time period ranging from about 10-50 minutes; and
c. Stirring the reaction mixture for about 2 to 6 hours to obtain the ionic liquid-solvent complex.

In another embodiment of the present disclosure, the stirring of steps (a) and (b) is carried out for a period of about 30 minutes, the stirring of step c) is carried out for a period ranging from about 2 to 3 hours and the temperature is preferably ranging from about 15-200° C.

In yet another embodiment of the present disclosure, the solvent forms a clathrate with [UMiXj].

In a non-limiting embodiment, the solvent is organic solvent including but not limiting to ethyl acetate, benzene, toluene, ethanol, acetic acid, acetone, acetonitrile, butanol, t-butyl alcohol, carbon tetrachloride, chlorobenzene, chloroform, cyclohexane, 1,2-dichloroethane, heptane, hexane, methanol, methylene chloride, nitromethane, pentane, propanol and xylene.

In an exemplary embodiment of the present disclosure, the solvent is an aromatic solvent selected from a group comprising benzene, toluene, chlorobenzene, cyclohexane and xylene.

In a preferred embodiment, the solvent is benzene or toluene, preferably benzene.

In a non-limiting embodiment of the present disclosure, the solvent is added during the preparation of ionic liquid.

In a non-limiting embodiment of the present disclosure, adding solvent/benzene while preparation of ionic liquid has an advantage that no heating is required for the formation of ionic liquid.

In a non-limiting embodiment of the present disclosure, adding solvent/benzene while preparation of ionic liquid accommodates more solvent in the ionic liquid.

In another embodiment, the specific sequence of addition of the reagents in the preparation of the ionic liquid solvent complex plays an important role in minimizing the amount of the catalyst required for the reaction.

In another embodiment, the specific sequence of addition of the reagents in the preparation of the ionic liquid solvent complex plays an important role in reducing the viscosity of the ionic liquid-solvent complex.

In another embodiment of the present disclosure, if the ionic liquid is made with 0% benzene (i.e. without benzene) and later diluted with benzene it can only take 40% by weight of benzene. However, when benzene is used while preparing the ionic liquid, the Ionic Liquid first can take up to 70% benzene. Therefore, process of preparing ionic liquid solvent complex of the present disclosure requires the addition of solvent during and not after its preparation as this affects the capacity of the Ionic liquid to hold the solvent within it during the reaction.

In a non-limiting embodiment of the present disclosure, the ionic liquid-solvent complex is comprised of a deep eutectic mixture of various chloroaluminates with solvents.

In a non-limiting embodiment of the present disclosure, cation complexes with anion in the presence of organic solvent to form a eutectic complex [U-MᵢXⱼ]⁻ organic solvent.

In an exemplary embodiment, urea complexes with AlCl₃ in the presence of benzene to form a eutectic complex [U-AlCl₃]⁻ benzene. Similarly, urea complexes with various metal halides to result a deep eutectic solvent in presence of organic solvent.

In a non-limiting embodiment of the present disclosure, the ionic liquid-solvent complex has very less viscosity.

In a non-limiting embodiment of the present disclosure, the ionic liquid-solvent complex has longer shelf life and is highly stable.

In a non-limiting embodiment of the present disclosure, the ionic liquid-solvent complex finds application in, including but not limiting to, chemical and biological reactions, electric battery or cells, treating contaminated water, purification of gases and as, catalyst, solvent etc.

In a non-limiting embodiment of the present disclosure, the ionic liquid-solvent complex finds application in catalysing chemical reactions including but not limiting to alkylation, trans-alkylation, acylation, alkyl-sulfonation, polymerization, dimerization, oligomerization, isomerization, acetylation, metatheses, Diels-Alder reaction, pericyclic and copolymerization reactions. Thus, the ionic liquid-solvent complex is used as a catalyst for various reactions.

In a non-limiting embodiment of the present disclosure, the ionic liquid-solvent complex finds application in catalysing chemical reactions including but not limiting to Friedel crafts reactions.

The present disclosure also relates to a process for carrying out reactions, said process comprising step of catalysing the reactions in presence of the ionic liquid-solvent complex.

In an embodiment, the present disclosure relates to a process for alkylation of aromatic compound.

In an embodiment, the aromatic compound to be alkylated by the process of the present disclosure is aromatic hydrocarbon or substituted aromatic hydrocarbon such as, but not limiting to, benzene or substituted benzenes such as toluene, chlorobenzene, ethyl benzene, xylenes, cumene, other mono and poly lower alkyl benzenes or poly aromatic hydrocarbons having carbon atoms ranging from about 2 to 50 with an olefin having carbon atoms ranging from about 2 to 50 or mixture of olefins.

In another embodiment, the aromatic compound to be alkylated is benzene or derivatives of benzene, preferably benzene.

In an embodiment, the catalyst (ionic liquid) for alkylation of aromatic compounds is strong Lewis acid based ionic liquid having general formula [UMᵢXᵢ], wherein,

U represents cation selected from group comprising amide, phosphine and phosphine Oxide; [MᵢXⱼ] represents anion; wherein M represents metal selected from a group comprising Al, Fe, Zn, Mn, Mg, Ge, Cu and Ni; X represent halogen selected from a group comprising F, Cl, Br and I; and i and j represents 1 to 6.

The present disclosure also relates to a process for manufacturing linear alkyl benzene (LAB), wherein the process comprises acts of:
a. contacting benzene with olefin feed stock to obtain the pre-mixed feed or the hydrocarbon layer;
b. mixing the pre-mixed feed or the hydrocarbon layer of step a) with the ionic liquid-solvent complex of claim 1 to obtain a reaction mixture comprising hydrocarbon layer and ionic liquid-solvent complex layer; and
c. processing the reaction mixture of step b) to obtain the linear alkyl benzene.

In an embodiment of the present disclosure, the olefin feed stock comprises olefin or a mixture of olefins or a mixture of olefins and paraffins.

In an embodiment of the present disclosure, the olefin or paraffin has carbon atoms ranging from about 2 to 50, preferably about 8 to 15.

In an embodiment of the present disclosure, the mixing of step b) occurs at temperature ranging from about 5° C. to 150° C., preferably at about 30 to 800° C. and pressure at ambient pressure of about 1-10 atmospheres, preferably about 1-5 atmospheres.

In an embodiment of the present disclosure, the benzene to Olefin molar ratio is about 1:1 to 15:1, preferably 2:1 to 8:1.

In an embodiment of the present disclosure, the processing of step c) comprises separating the hydrocarbon layer from the ionic liquid-solvent complex layer.

In an embodiment of the present disclosure, the process further comprises subjecting the separated hydrocarbon layer to deacidification and the ionic liquid-solvent complex layer to re-use or recovery.

In an embodiment of the present disclosure, the process comprises subjecting the separated hydrocarbon layer to deacidification and the ionic liquid-solvent complex layer to catalytic recovery unit.

In an embodiment of the present disclosure, the process further comprises subjecting the deacidified hydrocarbon layer to fractionation and distillation and obtaining pure linear alkyl benzene (LAB).

In another embodiment, the olefins employed in the alkylation reaction are having carbon atoms ranging from 2 to 50, preferably from about 8 to 15. The olefins are alpha, linear, straight chain or branched chain olefins. The olefin feed stock is either purely olefin or a mixture of two or more olefins or a mixture of olefins and paraffins. In the said mixture of olefins and paraffins, the feed is either single olefin with single paraffin or single olefin with mixture of two or more paraffin's or mixture of two or more olefins with single paraffin or mixture of two or more olefins and two or more paraffins. The paraffins employed have carbon atoms ranging from about 2 to 50, preferably from about 8 to 15.

In another embodiment of the present disclosure, the ionic liquid employed as catalyst for catalysing reactions are in the form of ionic liquid solvent complex wherein the solvent forming a complex with ionic liquid is the same solvent/aromatic compound that is to be alkylated.

In an embodiment of the present disclosure, the manufacturing process has a process stream which contains aromatic hydrocarbon or substituted aromatic hydrocarbon such as benzene and a process stream containing olefins having carbon atoms ranging from about 2 to 50 with single paraffin or single olefin with mixture of two or more paraffins or mixture of two or more olefins with single paraffin or mixture of two or more olefins and two or more paraffin's having carbon atoms ranging from about 2 to 50, preferably from about 8 to about 15 with catalyst stream containing the ionic liquid solvent complex in a stirred reactor at a temperature ranging from about 5° C. to 150° C. and a pressure at ambient pressure of about 50 atmospheres. Aromatic to Olefin molar ratio of about 1:1 to 15:1, preferably 2:1 to 8:1 can be employed.

In another embodiment, the hydrocarbon layer obtained after the reaction followed by settling, is subjected to deacidification carried out by water/NaOH wash or by centrifugation or alumina treater or by acid stripper in a purifier (PR). The de-acidified layer is then distilled out to remove the alkylated product. The catalyst layer (ionic liquid-solvent complex layer) obtained after reaction is either recycled as such or recycled after regeneration.

In an embodiment of the present disclosure, the mixing and the separating is carried out by use of a at least one mixer/one settler respectively.

In an embodiment of the present disclosure, the mixing and the separating is carried out by use of a series of mixers/settlers arranged alternatively or in any combination.

In an embodiment of the present disclosure, the mixer is selected from a group comprising stirred vessel, plug flow reactor, static mixer, jet mixer, pump mixer and combinations thereof.

In another embodiment of the present disclosure, the settler is a gravity settling vessel which is either horizontal or vertical and the settling is selected from group comprising, single step settling or multi-step settling with a series of settlers which is selected from group comprising horizontal or vertical.

In another embodiment, there is one mixer M1 with one settler or two mixers M1 & M2 with two settlers or any combinations thereof.

In another embodiment, optionally another settler can be included between M1 & M2 if required.

In another embodiment, the purifier is selected from group comprising stirred vessel, centrifuge separator, packed column packed with alumina or a combination thereof in order to remove acid traces.

In an embodiment of the present disclosure, the LAB production process requires lower amount of the catalyst i.e., ionic liquid.

In an embodiment, the liquid clathrate compounds are formed by interactions between aromatic molecules i.e. benzene and Ionic Liquid (ionic solid) ions which separate cation-anion packing interactions to a sufficient degree such that localized cage-structures are formed. If the interaction is very less, the ionic liquid is completely miscible/immiscible with the aromatic compounds and if the ion-ion interactions are very high, then crystallization of the salt/ionic liquid occurs. Thus the liquid clathrate formation primarily depends on the physical properties of the organic salts. This is responsible for the amount of solvent taken by ionic liquid and in turn responsible for the density and viscosity of the ionic liquid, which are important physical parameters for design of catalysis process.

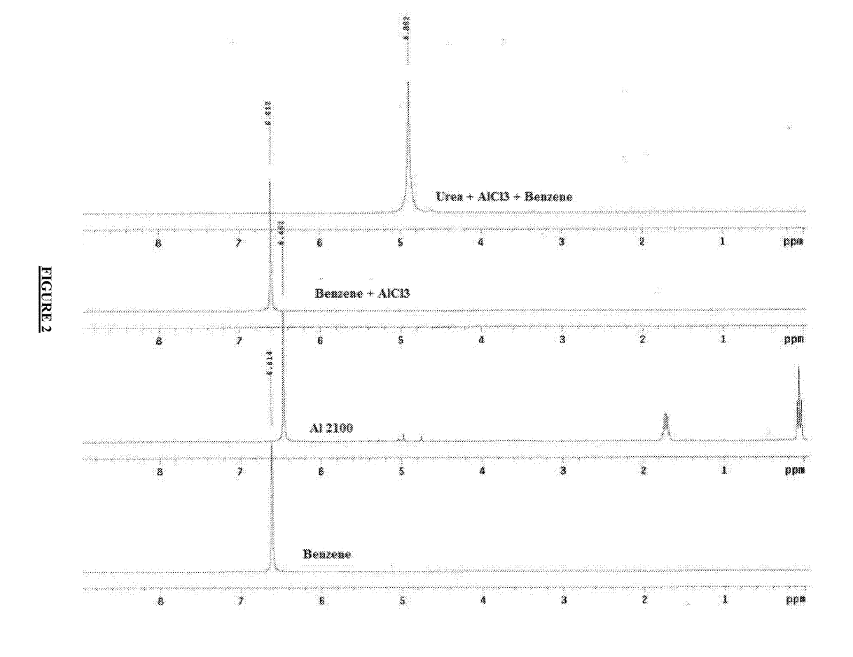

The liquid clathrate formation is proven by the NMR studies (FIG. 2), which show the protons of benzene going up field (from 6.614 to 4.892 ppm) after clathrate formation. Urea AlCl3-Benzene Ionic Liquid (IL) represents the IL formed by using benzene during the preparation of Ionic Liquid. Here, as benzene is forming a clathrate with ionic liquid the protons of benzene shifts up field. The interaction in this case is very strong and hence the shift is nearly of delta 1.9. Benzene-AlCl₃ Peak indicates the AlCl₃ dissolved in Benzene, where there is very less interaction and the shift is very less. Benzene is taken as a reference point.

The advantages offered by the Ionic liquid-solvent complex are provided as below:
The ionic liquid-solvent complex provides for less requirement of the catalyst/Ionic liquid for the reactions carried. Also, ionic liquid-solvent complex is less viscous. Therefore, the ionic liquid solvent complex of the present disclosure provides for a faster and cheaper catalyst when compared to those known in the art.
There is no requirement of heating for formation of the ionic liquid as the ionic liquids possess an organic solvent like benzene.
Improvement of transport properties of the ionic liquid is possible thereby overcoming resistances during various catalytic reaction process.
As the viscosity of the catalyst/ionic liquids is low, it is very easy for pumping it at the time of catalyst addition in the reaction.
As the density of the ionic liquid is less, it is easy for mixing it with reaction mixture at the time of reaction (reaction mixture density and IL density difference is less).

Additional embodiments and features of the present disclosure will be apparent to one of ordinary skill in art based upon description provided herein. The embodiments herein provide various features and advantageous details thereof in the description. Descriptions of well-known/conventional methods and techniques are omitted so as to not unnecessarily obscure the embodiments herein. The examples provided herein are intended merely to facilitate an understanding of ways in which the embodiments herein may be practiced and to further enable those of skill in the art to practice the embodiments herein. Accordingly, the following examples should not be construed as limiting the scope of the embodiments herein.

### EXAMPLES

### Example 1: Preparation of Ionic Liquid-Solvent Complex from Urea, AlCl3 & Benzene

10 g (0.166 mol) of Urea is charged into a 100 ml RB flask kept under an overhead stirrer. Then, 12.5 g of benzene is added and whole assembly is kept under N₂ atmosphere and stirred for 30 min. The flask is immersed in a water bath kept at 15-20° C. Slowly under stirring, 44.4 g (0.333 mol) of AlCl₃ is added for 30 minutes. After addition, the whole mass is stirred for 2-3 h resulting in the formation of Urea-AlCl₃-benzene complex.

### Example 2: Preparation of Ionic Liquid-Solvent Complex from Dimethylformamide (DMF), AlCl3 & Benzene

12.13 g (0.166 mol) of DMF is charged into a 100 ml RB flask kept under an overhead stirrer. Then, 12.5 g of benzene is added and whole assembly is kept under N₂ atmosphere and stirred for about 30 minutes. The flask is immersed in a water bath kept at 15-20° C. Slowly under stirring, 44.4 g (0.333 mol) of AlCl₃ is added for about 30 minutes. After addition, the whole mass is stirred for about 2-3 hours resulting in the formation of DMF-AlCl₃-benzene complex.

### Example 3: Preparation of Ionic Liquid-Solvent Complex from Triphenylphosphine (TPP), AlCl₃ & Benzene

43.5 g (0.166 mol) of TPP is charged into a 100 ml RB flask kept under an overhead stirrer. Then, 25 g of benzene is added and whole assembly is kept under N₂ atmosphere and stirred for about 30 minutes. The flask is immersed in a water bath kept at 15-20° C. Slowly under stirring, 44.4 g (0.333 mol) of AlCl₃ is added for 30 minutes. After addition, the whole mass is stirred for about 2-3 hours resulting in the formation of TPP-AlCl3-benzene complex.

### Example 4: Oligomerization Reaction by Urea-AlCl₃-Benzene Complex Prepared in Example 1

About 100 ml of hydrocarbon stream containing about 10% to about 13% of C₁₀-C₁₄ olefins and about 87% to about 90% of paraffins are charged into a 250 ml glass reactor kept under an overhead stirrer, placed in a heating mantle. N₂ flow is ensured inside the reactor. The reactor is then heated to about 45° C. Once the temperature is achieved, about 0.09 g of the Urea-AlCl₃-Benzene complex prepared as per Example 1 is added to the reactor and stirred for about 10 minutes. After about 10 minutes, the reaction mass is allowed to settle for about 10 minutes. The layers are then separated. The upper hydrocarbon layer is then analysed. The conversion of olefins is analysed and found to be about 96%.

### Example 5: Diels-Alder Reaction by Urea-AlCl₃-Benzene Complex Prepared in Example 1

About 2.76 g of Isoprene and about 1.02 g Vinyl Acetate are charged into a 100 ml glass reactor kept under an overhead stirrer, placed in a heating mantle. N₂ flow is ensured inside the reactor. The reactor is then heated to a temperature of about 60° C. Once the temperature is achieved, about 0.03 g of the Urea-AlCl₃-benzene complex prepared as per Example 1 is added to the reactor and stirred for about 4 hours. After about 4 hours, the reaction is worked-up with 10 ml ethyl acetate. The conversion of reactants is analysed and found to be about 94%.

### Example 6: Acylation Reaction by Urea-AlCl₃-Benzene Complex Prepared in Example 1

About 19.5 g of Benzene and about 3.5 g Acetyl Chloride are charged into a 100 ml glass reactor kept under an overhead stirrer, placed in a heating mantle. N₂ flow is ensured inside the reactor. The reactor is then heated to a temperature of about 60° C. Once the temperature is achieved, about 0.2 g of the Urea-AlCl3-benzene complex prepared as per Example 1 is added to the reactor and stirred for about 2 hrs. After about 2 hours, the reaction is worked-up with about 25 ml distilled water. The conversion of Acetyl Chloride is analysed and found to be about 95%.

### Example 7: Alkylation of Phenol by Urea-AlCl₃-Benzene Complex Prepared in Example 1

About 23.5 g of Phenol and about 2.2 g of Methyl tert-butyl ether (MTBE) are charged into a 100 ml glass reactor kept under an overhead stirrer, placed in a heating mantle. N₂ flow is ensured inside the reactor. The reactor is then heated to a temperature of about 60° C. Once the temperature is achieved, about 0.24 g of the Urea-AlCl3-benzene complex prepared as per Example 1 is added to the reactor and stirred for about 3 hours. After about 3 hrs, the reaction is worked-up with 25 ml distilled water. The conversion of MTBE is analysed and is found to be about 94%.

### Example 8: Alkylation of Benzene by Urea-AlCl₃-Benzene Complex (Catalyst) Prepared in Example 1

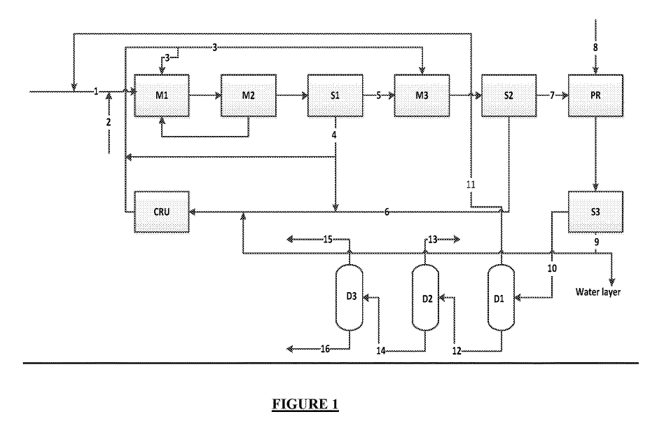

225 litres/hour (194 kg/hr) of benzene and 3 litres/hour of freshly prepared catalyst in Example-1 are mixed in a first static mixer and the mixture is then contacted with 425 litre/hr of olefin stream containing 10-15% C10-C14 olefins and 85-90% C10-C14 paraffins in second static mixer. The reaction mixture after from the second static mixer is sent into a vertical 2 stage separator, from where the top hydrocarbon layer is sent to Deacidification column and finally stored in a large storage vessel. The hydrocarbon layer is analysed for olefin content and the conversion of olefin obtained is 99.7%. The Linear alkyl benzene formation is confirmed by GC. The bottom catalyst layer from the separator is continuously collected and stored in a High density Polyethylene HDPE container. The process flow diagram for the alkylation of benzene with olefins is shown in FIG. 1 and has been briefly described below.

Reaction raw material is prepared by mixing benzene and olefin streams coming from lines 1 & 2 respectively (FIG. 1). The pre-mixed feed is then fed to mixer M1 where fresh/recycled/regenerated catalyst is added through line 3. The temperature in M1 is maintained between 30 to 80° C. with a pressure of 1 to 5 atmospheres. The mole ratio of benzene to olefin is in the range of 2:1 to 8:1. The volume ratio of catalyst to hydrocarbon feed is in the range of 0.1 to 1.5. The reaction takes place in M1. The outlet of M1 is directly fed into second mixer M2 where further reaction takes place. The temperature and pressure conditions in M2 can be same as M1 or can be different. Optionally, there can be a settler between M1 & M2 where the reaction mixture from M1 can be fed to the settler and after the layer separation, the upper hydrocarbon layer is transferred to M2 along with fresh catalyst and the lower catalyst layer can be recycled to mixer M1/M3 directly or through catalyst recovery unit CRU. The outlet from M2 is fed into settler S1 where hydrocarbon and catalyst layers are separated. The heavier catalyst layer from S1 via line 4 is recycled to mixer M1/M3 directly or through catalyst recovery unit CRU. The upper layer is hydrocarbon layer which is fed to mixer M3 via line 5 where fresh/recycled/regenerated catalyst is added via line 3. The outlet from M3 is fed into settler S2 where hydrocarbon and catalyst layers are separated. Optionally, there can be only one mixer M1 instead of M1, M2 & M3 where the outlet of M1 is fed into settler S2 or optionally, there can be two mixers M1 & M2 where the outlet of M2 is fed into settler S2. The heavier catalyst layer from S2 through line 6 is recycled to mixer M1/M3 through CRU. The upper hydrocarbon layer is fed to hydrocarbon layer purifier PR through line 7, where the hydrocarbon layer is washed with either water or alkali solution through line 8 or directly centrifuged without any addition of water or alkali solution to remove trace acid content in the hydrocarbon layer. The volume ratio of water or alkali solution to hydrocarbon layer is in the range of 0.2 to 1 & the concentration of alkali may range from 2-50% in alkali solution. The said purifier PR can also be a packed column filled with alumina to remove acidic traces in hydrocarbon layer. Alternatively, the deacidification section can be a stripper to strip off some benzene along with acidity in the form of HCl.

Also, the deacidification can be a combination of stripper followed by alumina treater or vice versa. The outlet from PR is directly fed to settler S3 where layer separation occurs. In case of water or alkali wash, the bottom layer will be aqueous layer with large quantity, which is sent for effluent treatment through line 9 while in case of centrifugation or crystallization, the bottom layer will be catalyst layer with very small quantity which is fed to CRU through line 9. The upper hydrocarbon layer from S3 is fed to fractionating column D1 where benzene is distilled off and recycled to line 1 through line 11. The residue of D1 is fed to fractionating column D2 through line 12 to remove and recover paraffin through line 13. The residue of fractionating D2 is fed to fractionating column D3 to separate linear alkyl benzene product by line 15 and heavy alkylated product by line 16. The distillation columns D1, D2 & D3 can be operated under pressure or atmospheric pressure or under vacuum.

Post distillation, pure LAB is isolated and the yield i.e. conversion of olefin to LAB is observed to be about 99.7%.

### Example 9: Reduced Viscosity and Quantity of the Ionic Liquid During the Alkylation Process

When the ionic liquid (IL) is prepared in the presence of aromatic solvent (such as benzene), the IL containing 0% to 72% of the solvent is achieved. If this IL is used and an excess amount of solvent is added, this IL loses some percentage of solvent and separates as IL containing 39-44% by weight of solvent.

This aspect has been validated here by taking 25 mL (26.75 g) of 70% benzene containing IL and slowly adding 75 mL of benzene and mixing the solution. When the ionic liquid is allowed to settle, the amount of IL layer which separates out is about 11 mL and the benzene layer is still remaining in the mixture. Thus, the amount of benzene lost from the IL layer is about 14 mL and the amount of benzene remaining in the IL is about 11 ml (25-14=11 mL). The 11 ml of IL has a density of about 1.24, hence the weight of the same is about 13.64 g (11×1.24). This separated IL layer has about 8.025 g of neat IL (i.e. pure IL) and 5.615 g of benzene (13.64−8.025=5.615 g). Thus, the percentage of benzene in IL is 41.16% (5.615/13.64=41.16%). It is clear from this that the use of solvent at the time of catalyst formation gives an advantage of higher amount of solvent accommodated in the catalyst. This means, given weight of the catalyst has less active sites actual catalyst which helps in spreading the catalyst in the reaction mixture. The second use of this is that once the catalyst is spread in the reaction mixture, it loses some solvent (in this case, benzene) making its density high and helping in settling of the catalyst once the reaction is over.

The higher amount of solvent accommodated in the catalyst is because of the liquid clathrate formed by addition of solvent during the preparation of ionic liquid. The liquid clathrate formation is proven by the NMR studies (FIG. 2), which show the protons of benzene going up field (from 6.614 to 4.892 ppm) after clathrate formation. Urea AlCl₃-Benzene Ionic Liquid (IL) represents the IL formed by using benzene during the preparation of Ionic Liquid. Here, as benzene is forming a clathrate with ionic liquid, the protons of benzene shifts up field. The interaction in this case is very strong and hence the shift is nearly of delta 1.9. Benzene-AlCl₃ Peak indicates the AlCl₃ dissolved in Benzene, where there is very less interaction and the shift is very less. Benzene is taken as a reference point.

The above study shows that the Ionic liquid formed in presence of benzene forming a complex with it gives an advantage of having lower viscosity and lesser dense ionic liquid at the time of reaction (catalyst introduction in the reaction). However, the ionic liquid gets denser in the later phase of the reaction where it settles down and loses some part of benzene into the reaction mass thereby making the catalyst to settle down.

Therefore, it is clear and evident that by using IL containing 70% of benzene (Ionic liquid-solvent complex), the amount of catalyst required for the alkylation reaction gets minimized or reduced.

While carrying out the reaction using IL containing 70% of benzene, the reaction is completed with just 0.15% of catalyst which is not possible with other reported ILs which require at least 0.25% of catalyst in order to carry out the alkylation reaction. Thus, it is evident that the ionic liquid-solvent complex and the process by which it is prepared minimize the amount of IL required as catalyst for carrying out reactions.

Additional embodiments and features of the present disclosure will be apparent to one of ordinary skill in art based on the description provided herein. The embodiments herein provide various features and advantageous details thereof in the description. Descriptions of well-known/conventional methods and techniques are omitted so as to not unnecessarily obscure the embodiments herein.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments in this disclosure have been described in terms of preferred embodiments, those skilled in the art will recognize that the embodiments herein can be practiced with modification within the spirit and scope of the embodiments as described herein.

Throughout this specification, the word “comprise”, or variations such as “comprises” or “comprising” wherever used, will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the disclosure to achieve one or more of the desired objects or results.

Any discussion of documents, acts, materials, devices, articles and the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

While considerable emphasis has been placed herein on the particular features of this disclosure, it will be appreciated that various modifications can be made, and that many changes can be made in the preferred embodiments without departing from the principles of the disclosure. These and other modifications in the nature of the disclosure or the preferred embodiments will be apparent to those skilled in the art from the disclosure herein, whereby it is to be distinctly understood that the foregoing descriptive matter is to be interpreted merely as illustrative of the disclosure and not as a limitation.

1. An ionic liquid-solvent complex represented by formula I,
[UMᵢXⱼ]S
wherein,
[UMᵢXⱼ] represents the ionic liquid and S represents organic solvent;
wherein,
U represents cation selected from group comprising amide, phosphine and phosphine Oxide;
[MᵢXⱼ] represents anion; wherein M represents metal selected from a group comprising Al, Fe, Zn, Mn, Mg, Ge, Cu and Ni; X represent halogen selected from a group comprising F, Cl, Br and I; and i and j represents 1 to 6.

2. The ionic liquid-solvent complex as claimed in claim 1, wherein the amide is selected from urea and dimethylformamide.

3. The ionic liquid-solvent complex as claimed in claim 1, wherein the solvent is selected from a group comprising benzene, toluene, ethyl acetate, ethanol, acetic acid, acetone, acetonitrile, butanol, t-butyl alcohol, carbon tetrachloride, chlorobenzene, chloroform, cyclohexane, 1,2-dichloroethane, heptane, hexane, methanol, methylene chloride, nitromethane, pentane, propanol and xylene.

4. The ionic liquid-solvent complex as claimed in claim 1, wherein the amide is urea; and wherein the solvent is benzene or toluene.

5. The ionic liquid-solvent complex as claimed in claim 1, wherein the solvent forms a clathrate with [UMᵢXⱼ].

6. The ionic liquid-solvent complex as claimed in claim 1, wherein the [UMᵢXⱼ]S is [Urea-AlCl₃]benzene.

7. A process for preparing the ionic liquid-solvent complex as claimed in claim 1, wherein the process comprises acts of:
a. adding organic solvent to a flask charged with cation under N₂ atmosphere and stirring reaction mixture for a time period ranging from about 10 minutes to 50 minutes;
b. immersing the flask in a water bath kept at a temperature of about 10-40° C. and adding anion under slow stirring of the reaction mixture for a time period ranging from about 10-50 minutes; and
c. Stirring the reaction mixture for about 2 to 6 hours to obtain the ionic liquid-solvent complex.

8. The process as claimed in claim 7, wherein the stirring of steps a) and b) is carried out for a period of about 30 minutes and the stirring of step c) is carried out for a period ranging from about 2 to 3 hours; wherein the solvent forms a clathrate with [UMᵢXⱼ] and wherein the process does not involve heating.

9. (canceled)

10. (canceled)

11. A process for carrying out reactions, said process comprising step of catalysing the reactions in presence of ionic liquid-solvent complex of claim 1.

12. The process as claimed in claim 11, wherein the reactions are chemical or biological reactions.

13. A process for manufacturing linear alkyl benzene (LAB), wherein the process comprises acts of:
a. contacting benzene with olefin feedstock to obtain the pre-mixed feed or the hydrocarbon layer;
b. mixing the pre-mixed feed or the hydrocarbon layer of step a) with the ionic liquid-solvent complex of claim 1 to obtain a reaction mixture comprising hydrocarbon layer and ionic liquid-solvent complex layer; and
c. processing the reaction mixture of step b) to obtain the linear alkyl benzene.

14. The process as claimed in claim 13, wherein the olefin feed stock comprises olefin or a mixture of olefins or a mixture of olefins and paraffins; and wherein the olefin or paraffin has carbon atoms ranging from about 2 to 50.

15. (canceled)

16. The process as claimed in claim 13, wherein the mixing of step b) occurs at temperature ranging from about 5° C. to 150° C. and pressure at ambient pressure of about 1-10 atmospheres.

17. The process as claimed in claim 13, wherein the benzene to Olefin molar ratio is about 1:1 to 15:1.

18. The process as claimed in claim 13, wherein the processing of step c) comprises separating the hydrocarbon layer from the ionic liquid-solvent complex layer.

19. The process as claimed in claim 18, wherein the process further comprises subjecting the separated hydrocarbon layer to deacidification and collecting the ionic liquid-solvent complex layer for re-use or recovery.

20. The process as claimed in claim 19, wherein the process further comprises subjecting the deacidified hydrocarbon layer to fractionation and distillation and obtaining pure Linear alkyl benzene (LAB).

21. The process as claimed in claim 20, wherein the deacidification is carried out by technique selected from group comprising, water wash, NaOH wash, centrifugation, alumina treater, by acid stripper in a purifier and combinations thereof; wherein the purifier is selected from group comprising stirred vessel, centrifuge separator, packed column packed with alumina and combination thereof.

22. The process as claimed in claim 13, wherein the olefin or paraffin has carbon atoms ranging from about 8 to 15; and wherein the benzene to Olefin molar ratio is about 2:1 to 8:1.

23. The process as claimed in claim 13, wherein the mixing of step b) occurs at temperature ranging from about 30° C. to 80° C., and pressure of about 1-5 atmospheres.
